(19) United States
(12) Patent Application Publication
(10) Pub. No.: US 2023/0389597 A1
(43) Pub. Date: Dec. 7, 2023

(54) METHOD AND APPARATUS FOR MANUFACTURING A COMPONENT OF AN AEROSOL GENERATING ARTICLE

(71) Applicant: Philip Morris Products S.A., Neuchâtel (CH)

(72) Inventors: Matteo BALBONI, Sala Bolognese (IT); Daniele SASSI, Sasso Marconi (IT)

(73) Assignee: Philip Morris Products S.A., Neuchâtel (CH)

(21) Appl. No.: 18/249,796

(22) PCT Filed: Oct. 26, 2021
(86) PCT No.: PCT/EP2021/079737

§ 371 Date: Apr. 20, 2023

(30) Foreign Application Priority Data
Oct. 26, 2020 (EP) 20203982.2

(51) Int. Cl. A24C 5/18; A24C 5/01

(52) U.S. Cl. CPC A24C 5/1892; A24C 5/01; A24C 5/1807

(57) ABSTRACT

An apparatus for manufacturing a component of an aerosol-generating article is provided, the apparatus including: a conveyor configured to convey a band of material through the apparatus along a first path; and a device disposed along the first path, the device including: one or more nozzles configured to apply additive to the band of material, when the band of material passes the device, and a device body including a contact surface configured to contact the conveyed band of material as the band of material passes the device, the contact surface having a convex profile as viewed in a direction of the first path at the device; and a funnel having a first open end configured to receive the band of material and a second open end providing an exit point for the band of material, the first open end being positioned downstream of the device.

The present invention relates to a method and apparatus for manufacturing a component of an aerosol-generating article. The invention particularly relates to a method and apparatus for applying additive to a conveyed band of material for manufacturing a component of an aerosol-generating article.

Aerosol-generating articles in which an aerosol-generating substrate, such as a tobacco-containing substrate, is heated rather than combusted, are known in the art. Typically, in such aerosol-generating articles an aerosol is generated by the transfer of heat from a heat source to a physically separate aerosol-generating substrate or material, which may be located in contact with, within, around, or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol.

For some aerosol-generating articles, the aerosol-generating substrate is formed from a sheet of material which is gathered into a rod. The rod is formed by passing the sheet through a funnel, which shapes the sheet into the rod. The formed rod is then cut into discrete units for inclusion in one or more aerosol-generating articles. In some instances, it is desirable to spray or otherwise apply an additive, such as a flavourant, onto the sheet material before it is gathered into the rod. Consequently, some manufacturing apparatus include an additive chamber through which the sheet must pass before the sheet is passed through the funnel. The additive deposition chamber may comprise an enclosed space containing multiple nozzles for depositing the additive onto the sheet as the sheet passes through the chamber.

The use of such additive deposition chambers may present a number of drawbacks. For example, the additive deposition chamber may not allow for precise control of one or both of the amount of additive and location of the additive which is deposited on the sheet of material. The additive deposition chamber may also require regular cleaning.

Known additive deposition techniques may also involve the additive only being applied to the top surface of the sheet as the sheet passes through the chamber. This may be because the additive deposition is reliant on gravity. This may lead to problems when the sheet passes through a funnel after the additive deposition chamber, since the top surface of the sheet carrying the additive may come into direct contact with the inner surface of the funnel. Such contact may impact one or both of the amount or the location of the additive carried by the sheet. The contact may also impact the performance of the funnel, including the amount of time the funnel can be used before cleaning is required.

It would be desirable to provide an improved method and apparatus for manufacturing a component of an aerosol-generating article. It would also be desirable to provide a method and apparatus which does not suffer from one or more of the aforementioned drawbacks.

The present disclosure relates to an apparatus for manufacturing a component of an aerosol-generating article. The apparatus may comprise a conveyor for conveying a band of material through the apparatus along a first path. The apparatus may comprise a device disposed along the first path. The device may comprise one or more nozzles. The one or more nozzles may be configured to apply additive to the band of material when the band of material passes the device. The device may comprise a contact surface for contacting the conveyed band of material as the conveyed band of material passes the device. The contact surface may have a convex profile as viewed in the direction of the first path at the device.

The present disclosure also relates to a method of applying additive to a conveyed band of material in an apparatus for manufacturing a component of an aerosol-generating article. The method may comprise: providing a device comprising one or more nozzles for applying additive to a band of material. The method may comprise conveying a band of material through the apparatus and past a device. The conveying step may be such that the band of material comes into contact with a convex contact surface of the device. The method may comprise transferring additive from one or more nozzles of a device to a band of material as the band of material is conveyed past a device.

According to at least one example of the disclosure, there is provided an apparatus for manufacturing a component of an aerosol-generating article, the apparatus comprising: a conveyor for conveying a band of material through the apparatus along a first path; and a device disposed along the first path. The device comprises one or more nozzles configured to apply additive to the band of material, when the band of material passes the device; and a device body comprising a contact surface for contacting the conveyed band of material as the band of material passes the device. The contact surface has a convex profile as viewed in the direction of the first path at the device. The contact surface may be referred to herein as a convex contact surface or convex surface. Viewing of the convex profile may be taken from a point which the band of material passes upstream of the device. The point may be immediately upstream of the device. The point may be between about 10 centimetres and about 20 centimetres.

The apparatus may further comprise a funnel having a first open end configured to receive the band of material and a second open end providing an exit point for the band of material, the first open end being positioned downstream of the device.

According to at least one example of the disclosure, there is provided a method of applying additive to a conveyed band of material in an apparatus for manufacturing a component of an aerosol-generating article. The method comprises: providing a device comprising one or more nozzles for applying additive to a band of material, conveying the band of material through the apparatus and past the device, such that the band of material comes into contact with a convex contact surface of the device; and transferring additive from the one or more nozzles of the device to the band of material as the band of material is conveyed past the device. The method may further comprise the steps of: providing a funnel having a first open end configured to receive the band of material and a second open end providing an exit point for the band of material, the first open end being positioned downstream of the device; and conveying the band of material with transferred additive through the first open end of the funnel and out of the second open end of the funnel.

By providing the device with a contact surface having a convex profile as viewed in the direction of the first path, the shape of the band of material may be modified as it passes the device. In particular, the convex surface can act to stretch or otherwise spread the band of material in a curved shaped around the device as the band of material passes the device. This can provide a number of advantages. For example, spreading the band of material around the device may help to prevent or otherwise suppress unwanted folding or deformities in the band of material as the band of material passes the device. This may help to increase one or both of the accuracy of additive application and consistency of additive application to the band of material.

Furthermore, when the band of material is a crimped sheet of material, the convex surface may help to increase the accessible surface area of the crimped sheet available for additive application by reducing the severity of crimping in the sheet material when the sheet material is passing the device. Consequently, with such a crimped sheet of material, an increase in the one or both of the accuracy of additive application and consistency of additive application can be achieved.

Stretching or otherwise spreading the band of material in a curved shaped around the device as the band of material passes the device can also be advantageous when the band of material is to be shaped into a rod after the band of material has passed the device. In particular, using the convex surface of the device to manipulate the band of material into a curved shape around the device can advantageously act as a preparatory step for forming the rod from the band of material. This is because the device may place the band of material in a curved shape, which is better suited to passing through a funnel or other device used to form the rod. This may lead to one or both of improvements in the consistency of the rod formed by the apparatus, and improvements in the operation of the apparatus.

The device may comprise a device body. The device body may have a first side. The first side may be oriented towards a downstream direction of the first path of the conveyed band of material. That is, the first side may face the direction which the band of material travels after the band of material passes the device.

The device body may have a second side. The second side may be oriented towards an upstream direction of the first path of the conveyed band of material. That is, the second side may face towards the band of material as the band of material approaches the device. The second side of the device body may therefore oppose the first side of the device body. The device body may have a first axis extending therethrough between the first side of the device body and the second side of the device body. The first axis may be substantially aligned with the direction of the first path of the band of material at the device.

The contact surface may be part of the device body and may reside between the first side of the device body and the second side of the device body. The contact surface may therefore have a convex profile as viewed along the first axis of the body of the device.

Accordingly, the present disclosure also provides for a device for applying additive to a conveyed band of material in an apparatus for manufacturing a component of an aerosol-generating article, the device comprising: a device body having a first axis extending therethrough between: a first side of the device body configured to face in a downstream direction of the conveyed band of material; and an opposed second side of the device body configured to face in an upstream direction of the conveyed band of material; a contact surface for contacting the conveyed band of material as the band of material passes the device, the contact surface residing between the first side of the device body and the second side of the device body; and one or more nozzles for applying additive to the conveyed band of material as the conveyed band passes the contact surface, wherein the contact surface has a convex profile as viewed along the first axis of the body of the device.

The contact surface has a convex profile as viewed in the direction of the first path at the device. Therefore, the contact surface may extend in a direction perpendicular to the direction of the first path.

Each of the one or more nozzles may comprise an outlet defined by the contact surface. For example, the contact surface may define one or more holes on the surface of the device, with each hole defining the outlet of a nozzle. The one or more nozzles may therefore enable additive to be directly applied to portions of the band of material as said portions of the band of material come into contact with the contact surface of the device. This may help to improve the transfer of additive to the band of material. For example, this may help to improve the efficiency of transfer of additive to the band of material, since there is reduced likelihood of additive settling on other components of the system.

The one or more nozzles may be provided within the device body. In such embodiments, the device may comprise one or more internal bores with each internal bore forming a nozzle of the one or more nozzles. Alternatively or additionally, the device may comprise an outer shell which provides the contact surface and the one or more nozzles may be located within the outer shell.

In some embodiments, the one or more nozzles are a plurality of nozzles. The plurality of nozzles may be distributed on the device in any suitable manner. Preferably, the plurality of nozzles have outlets distributed along the convex profile of the contact surface. The outlets of the plurality of nozzles may be uniformly distributed along the convex profile of the contact surface. Such distribution may provide for improved application of additive to the band of material. For example, such distribution may enable the additive to be evenly distributed across at least a portion of the band of material.

The device may comprise a device body having any suitable shape which provides for a contact surface having a convex profile as viewed in the direction of the first path at the device. For example, the device body may be in the shape of a disc having a rim, with the convex profile of the contact surface being defined by the rim of the disc.

In some embodiments, the device body may be in the form of an at least partial disc having a rim, and wherein the convex profile is defined by the rim of the at least partial disc. For example, the device body may be in the form of a semi-circular disc, with the curved rim of the semi-circular disc defining the convex profile of the contact surface.

The rim of the at least partial disc may be curved in only one direction, with this curve providing the convex profile of the contact surface. Alternatively, the rim of the at least partial disc may be rounded. A rounded rim may advantageously help to guide the band of material towards and away from the contact surface of the device. This may help to improve the extent to which the band of material interacts with the contact surface. Consequently, this may help to improve the extent to which the band of material can be stretched or otherwise spread in a curved shaped around the device as the band of material passes the device. A rounded rim may also advantageously help with any gathering of the band of material which is performed downstream of the device. For example, where a funnel is placed downstream of the device, the rounded rim may provide a complementary surface to the shape of the funnel as the band of material leaves the device. This may help to guide the band of material along a trajectory which promotes improved gathering of the band of material at the funnel.

The rim of the at least partial disc may comprise a groove extending along the curvature of the rim. The outlet of each of the one or more nozzles may be disposed in the groove. Such an arrangement may allow the one or more nozzle outlets to be sunken from the contact surface. The groove may advantageously allow for a desired quantity of the additive to reside at the contact surface ready for application to the band of material. The additive may therefore be applied to the band of material by smearing as the band of material passes over the groove containing the additive. This may be particularly suitable when the additive comprises one or both of a liquid and a gel. Smearing of the additive onto the band of material may be a particularly effective means for ensuring consistency in the application of the additive.

In some embodiments, the device body may comprise a central element and a plurality of spaced apart walls radially extending outwardly from the central element and following one another in a circumferential direction around the central element. The contact surface may comprise an end surface of each of the plurality of spaced apart walls. The end surface of a wall may be considered the top surface of the wall. The convex profile of the contact surface may therefore be defined by the manner in which the end surfaces of the plurality of spaced apart walls are distributed around the central element of the device body. Consequently, in such embodiments the contact surface is formed by a plurality of surfaces rather than a single surface.

In such embodiments, as the band of material reaches the device, the band of material passes into contact with the end surface of at least some of the spaced apart walls. Since these end surfaces are distributed in a convex profile around the central element, the band of material may therefore be subjected to similar forces as would be produced if the band of material were passed over a single continuous convex surface. That is, the spaced apart walls, and in particular their end surfaces, can help to stretch or otherwise spread the band of material in a curved shaped around the device as the band of material passes the device. Consequently, such embodiments may benefit from one or more of the aforementioned advantages relating to stretching or otherwise spreading the band of material in a curved shaped around the device as the band of material passes the device.

By providing a plurality of spaced apart walls radially extending outwardly from the central element, an empty space may be formed between two adjacent spaced-apart walls. The central element and the plurality of spaced apart walls may define a substantially star-shaped object.

The central element may be substantially cylindrical shaped. The central element may be a cylinder. A longitudinal axis of the central element may extend in substantially the same direction as the first path of the band of material at the device. The longitudinal axis of the central element may be the first axis discussed above. The longitudinal axis of the central element may therefore be substantially aligned with the direction of the first path of the band of material at the device.

Where the device body comprises a plurality of spaced apart walls radially extending outwardly from the central element, each wall may have a substantially constant height with respect to the central element. That is, the height of each wall may remain substantially constant when moving along the longitudinal axis of the central element.

Alternatively or additionally, the height of one or more of the plurality of spaced apart walls may increase when moving along the longitudinal axis of the central element from a first side of the device body to a central portion of the device body. Alternatively or additionally, the height of one or more of the plurality of spaced apart walls may increase when moving along the longitudinal axis of the central element from a second side of the device body to a central portion of the device body. Therefore, in some embodiments, the height of the one or more walls may peak in a central portion of the device body and decrease when moving from the central portion of the device body towards one or both of the first side of the device body and second side of the device body. Configuring the height of the one or more walls in one or more of the manners discussed above may advantageously help with one or both of guiding the band of material towards contact surface of the device, and guiding the band of material away from the contact surface of the device, for instance, to a funnel positioned downstream of the device. This may help to improve the extent to which the band of material interacts with the contact surface during use of the apparatus. Consequently, this may help to improve the extent to which the band of material can be stretched or otherwise spread in a curved shaped around the device as the band of material passes the device.

The device may comprise a hole extending through the device body from a first end of the device body to a second end of the device body. The hole may be positioned away from the contact surface. The hole may be positioned away from the one or more nozzles. The hole may provide a space through which another band of material may be conveyed. That is, the hole may provide a space for another band of material to pass the device without interacting with the contact surface or one or more nozzles of the device. By way of example, the apparatus may be configured to convey another band of material, such as a band of susceptor material, through the hole in the device body.

The device may further comprise an additive inlet in fluid communication with the one or more nozzles. The additive inlet may comprise an opening through which additive may pass into the device and move to the one or more nozzles. The additive inlet may be formed in the device body. The additive inlet may be defined by a surface of the device body which is separate from the contact surface.

The device may further comprise an additive conduit within the device body for transferring additive from the additive inlet to the one or more nozzles. The additive conduit may comprise one or more channels within the device connecting the additive inlet with the one or more nozzles. The additive conduit may be in direct fluid communication with the one or more nozzles. Alternatively or additionally, the device may further comprise an additive chamber within the device body for transferring additive from the additive conduit to the one or more nozzles. The additive chamber may delimit an empty space within the device body for containing a reservoir of additive. This may enable the device to contain sufficient additive for prolonged use.

The one or more nozzles may be configured to apply additive to the conveyed band of material as the conveyed band passes the contact surface. The one or more nozzles may be configured to spray the additive onto a surface of the conveyed band of material as the conveyed band of material passes the contact surface. The one or more nozzles may be configured to apply the additive onto a surface of the conveyed band of material by way of smearing as the conveyed band of material passes the contact surface.

The one or more nozzles may be integrally formed with the device body. Alternatively or additionally one or more of the nozzles may be provided as discrete components which are positioned within the device body.

In some embodiments, the one or more nozzles are attached to an external portion of the device body. For example, where the device body comprises a central element and a plurality of spaced apart walls radially extending outwardly from the central element, the one or more nozzles may be located attached to the external surface of the central element and positioned in the space may be formed between two adjacent spaced-apart walls. In this way, the one or more nozzles may be configured to apply additive to portions of the band of material which pass between two or more of the spaced-apart walls of the device body.

Alternatively, or additionally one or more of the nozzles may be disposed within one or more of the spaced apart walls with an outlet of each of said one or more nozzles being defined by the top surface of said one or more of the spaced apart walls. For example, at least one of the spaced apart walls may contain a nozzle, with the outlet of the nozzle being defined by the top surface of the at least one spaced apart wall. In such embodiments, the one or more nozzles may be configured to apply additive to portions of the band of material which come into contact with the contact surface defined by the top surface of the spaced-apart walls.

The contact surface may also have a convex profile as viewed in a direction perpendicular to the direction of the first path at the device. Such a convex profile may for example be provided in embodiments where the device body has a rounded rim as previously described. Such a convex profile may also for example be provided in embodiments where the device body has spaced apart walls having varying heights as previously described.

The apparatus may further comprise a funnel positioned downstream of the device. The funnel may be configured to gather the band of material into a rod after the band of material has moved past the device. The funnel may comprise a first open end configured to receive the band of material and a second open end providing an exit point for the band of material. The first open end may be positioned The first open end may be larger than the second open end. That is, the first open end may have a cross-section which is larger than the second open end. The first open end may be considered to define the entrance of the funnel. The first open end or entrance of the funnel may be positioned closer to the device than the second open end. That is, the entrance of the funnel may face towards the device.

The first open end of the funnel may be positioned downstream of the device. Consequently, the second open end of the funnel may also be positioned downstream of the device. Put another way, the entirety of the funnel may be positioned downstream of the device. The band of material may therefore move completely past the device before the band of material reaches the funnel.

The device may be positioned less than 1 metre from the funnel, more preferably less than 60 centimetres from the funnel, even more preferably less than 40 centimetres from the funnel. The device may be positioned at least 5 centimetres from the funnel. In some embodiments, the device is positioned between 5 and 20 centimetres of the funnel. Providing a device within such close proximity of the funnel can advantageously reduce the amount of time the additive is on the band of material before the band of material is gathered into a rod. This may help to reduce the amount of additive which may be lost from the band of material during conveyance of the band of material in the apparatus. This may also help to reduce the footprint needed for the device within the apparatus.

The apparatus may further comprise a crimping device positioned upstream of the device. The crimping device may be configured to crimp the band of material. In particular, the crimped band of material consists of a plurality of ridges and grooves. The crimping device may be configured to crimp the band of material so that the ridges and grooves created on the crimped band of material run in a direction parallel to its direction of conveyance. Crimping may provide a number of benefits. For example, crimping may assist with formation of the rod. As another example, crimping may provide the rod with one or more desired properties. However, crimping may also create challenges for applying additive to the band of material since the crimping process affects one or both of the structure and shape of the band of material. It can be challenging to apply additive to such a non-flat structure. It can be challenging to apply additive to such an uneven structure. For example, it can be challenging to evenly apply additive to such a structure because not all of the surface of the structure is easily accessible. Alternatively or additionally, it can be challenging to apply additive to certain portions of the structure which are less accessible.

The device of the present invention can improve the way in which additive can be applied to a crimped band of material by bringing the crimped band of material into contact with a convex contact surface of the device and applying additive to the crimped band of material when it is in contact with the convex surface. In particular, the arrangement of the convex contact surface can help to pull or otherwise stretch the crimped band of material in a direction perpendicular to its direction of travel. This can reduce the severity of the crimping or corrugation in the band of material and thus help to increase the surface area of the crimped band which is readily available for additive application. In doing so, the device can apply additive to one or more regions of the band of material which may otherwise have been difficult to access. This can lead to one or both of increased accuracy in where the additive is applied on the band of material and improvements in evenly applying the additive to the band of material.

The apparatus may further comprise a pump for pumping additive to the one or more nozzles of the device. The pump may be separate from the device. The pump may be configured to pump additive into the device through the additive inlet of the device.

The apparatus may further comprise the additive. The additive may be provided in the form of a gas. The additive may be provided in the form of an aerosol. The additive may be provided in the form of a liquid. The additive may be provided in the form of a gel.

The additive may include at least one flavourant. The at least one flavourant may comprise at least one of menthol, linalool, thymol, eucalyptol, methyl salicylate, and combinations thereof. Additionally, or alternatively, the at least one flavourant may comprise at least one of lemon oil, peppermint oil, parsley oil, champignon essence, green tea extract, oolong tea extract, mugwort drawing-extract, apple extract, kaki-fruit extract, ginger essence, and combinations thereof.

The at least one flavourant may comprise one or more volatile components, such as menthol.

The at least one flavourant may comprise a diluent. The diluent may comprise at least one of palm oil and a medium-chain triglyceride.

Many naturally occurring flavourants can be obtained either by extraction from a natural source or by chemical synthesis if the structure of the compound is known. The flavourants can be extracted from a part of a plant or an animal by physical means, by enzymes, or by water or an organic solvent, and thus include any extractive, essence, hydrolysate, distillate, or absolute thereof. Plants that can be used to provide flavourants include, but are not limited to, those belonging to the families, Lamiaceae (for example, mints), Apiaceae (for example, anise, fennel), Lauraceae (for example, laurels, cinnamon, rosewood), Rutaceae (for example, citrus fruits), Myrtaceae (for example, anise myrtle), and Fabaceae (for example, liquorice). Non-limiting examples of sources of flavourants include mints such as peppermint and spearmint, coffee, tea, cinnamon, clove, ginger, cocoa, vanilla, chocolate, eucalyptus, geranium, agave, juniper, lemon balm, basil, cinnamon, lemon basil, chive, coriander, lavender, sage, tea, thyme and caraway. The term “mints” is used to refer to plants of the genus Mentha. Suitable types of mint leaf may be taken from plant varieties including but not limited to Mentha piperita, Mentha arvensis, Mentha niliaca, Mentha citrata, Mentha spicata, Mentha spicata crispa, Mentha cordifolia, Mentha longifolia, Mentha pulegium, Mentha suaveolens, and Mentha suaveolens variegata.

The additive may comprise a component which provides one or more sensory effects other than a flavour sensation, such as a cooling or a warming sensation, a tingling sensation, a numbing sensation, effervescence, increased salivation, cough suppression, and combinations thereof. These sensory effects may be provided by one or more flavourants, including the flavourants listed above. Additionally, or alternatively, the additive may comprise at least one non-flavourant material which provides one or more of these sensory effects without providing a flavour sensation. For example, suitable compounds that produce a cooling effect and can be used as an active material include, but are not limited to, the family of carboxamide compounds, such as the Wilkinson-Sword (WS) compounds WS-3 (N-Ethyl-p-menthane-3-carboxamide), WS-23 (2-Isopropyl-N,2,3-trimethylbutyramide), WS-5 [Ethyl 3-(p-menthane-3-carboxamido)acetate], WS-27 (N-Ethyl-2,2-diisopropylbutanamide), WS-14 [N-([ethoxycarbonyl]methyl)-p-menthane-3-carboxamide], and WS-116 (N-(1,1-Dimethyl-2-hydroxyethyl)-2,2-diethylbutanamide). A suitable compound that provides a cough suppression effect is benzonatate.

The additive may comprise a plasticiser. The plasticiser may be a component which can be added to a band of fibrous filtration material to adjust the elastic properties of the fibrous filtration material. The plasticiser may be one or more of triacetin, triethylenglycol di-acetate and polyethylene glycol. The additive may comprise one or more of triacetin, triethylenglycol di-acetate and polyethylene glycol.

The apparatus comprises a conveyor for conveying the band of material through the apparatus along the first path. The conveyer may be any suitable means for conveying or otherwise transporting the band of material through the apparatus. For example, the conveyor may comprise one or more rollers configured to rotate to move the band of material through the apparatus. The one or more rollers may directly contact the band of material to move the band of material through the apparatus. Alternatively or additionally, the conveyor may comprise one or more conveyor belts and the one or more rollers may be configured to rotate to convey the one or more conveyor belts. In such embodiments, the one or more conveyor belts may be configured to directly contact the band of material to move the band of material through the apparatus. As a further alternative or additional example, the conveyor may comprise a pulling mechanism located downstream of the device in the apparatus. The pulling mechanism may be configured to pull the band of material from a position upstream of the device towards the pulling mechanism and past the device.

The band of material may be provided on a first bobbin. The conveyor for conveying the band of material through the apparatus along the first path may be configured to transport the band of material from the first bobbin to the device. For example, when the conveyor comprises a pulling mechanism positioned downstream of the device the pulling mechanism, the pulling mechanism may be configured to pull the band of material from the first bobbin towards the pulling mechanism and past the device.

In some embodiments the conveyor for conveying the band of material through the apparatus along the first path is a first conveyor. In such embodiments, the apparatus may further comprise a second conveyor for conveying a band of susceptor material through the apparatus. The second conveyor may comprise any of the features described above in respect of the first conveyor, such as the one or more rollers and the one or more conveyor belts. The second conveyor may be configured to convey the band of susceptor material past the device. The second conveyor may be configured to convey the band of susceptor material past the device without the band of susceptor material interacting with the device. The second conveyor may be configured to convey the band of susceptor material through a hole extending through the device body. The second conveyor may be configured to convey the band of susceptor material through a recessed portion of the device body. The second conveyor may be configured to convey the band of susceptor material such that the band of susceptor material is positioned within the gathered rod formed from the band of material conveyed by the first conveyor. The gathered rod is formed downstream of the device. The band of susceptor material may be provided on a second bobbin.

In some embodiments, the device for applying additive to the conveyed band of material is a first device, and the apparatus further comprises a second device for applying additive to the conveyed band of material. The second device may be positioned upstream of the first device.

The first device may be configured to apply a first additive to the conveyed band of material, and the second device may be configured to apply a second additive to the conveyed band of material. The first additive may be different from the second additive.

The first device may be configured to apply additive to a first portion of the conveyed band of material. The second device may be configured to apply additive to a second portion of the conveyed band of material. The first portion of the conveyed band of material may be different from the second portion of the conveyed band of material.

The first device may be configured to apply additive to a first side of the conveyed band of material. The second device may be configured to apply additive to a second side of the conveyed band of material. The first side of the conveyed band of material may be different from the second side of the conveyed band of material, such as being opposed to the second side of the conveyed band of material. In some embodiments, the first side of the conveyed band of material may be the top surface of the conveyed band of material and the second side of the conveyed band of material may be the bottom surface of the conveyed band of material.

The device body may comprise a first part configured to be held in a fixed position in the apparatus, and a second part configured to be removable from and attachable to the first part. The second part may be interchange with other second parts. This may allow for simple modification of one or more properties of the device. For example, the second part may comprise the contact surface of the device. By arranging for the second part to be removable from and attachable to the first part, the profile of the contact surface of the device can be easily changed by substituting out the second part for another second part having a contact surface with a different profile. The second part may comprise the one or more nozzles of the device. In this way, properties of the nozzles can be easily modified by interchanging the second part with another second part having nozzles with different properties. This can add significant flexibility to the use of the apparatus, without requiring the device to be completely uninstalled from the apparatus each time a modification in the performance of the device is desired. The first part may comprise the additive inlet connected to the pump of the apparatus.

The device may comprise a heater, such as an electric heater. The heater may be configured to heat one or more portions or components of the device. For example, where the device comprises an additive chamber, the heater may be configured to heat the additive chamber. Such an arrangement may enable the additive chamber and any additive contained therein to be heated to an elevated temperature. This may be advantageous for certain additives, such as additives having properties which benefit from the additive being maintained at elevated temperature. One example of such an additive is menthol, which may benefit from being maintained at an elevated temperature to reduce the likelihood of crystallisation of the menthol. Example elevated temperatures may include between about 40 degrees Celsius and about 80 degrees Celsius, more preferably between about 45 degrees Celsius and about 65 degrees Celsius.

The band of material may be a band of aerosol-forming substrate. The aerosol-forming substrate may comprise plant material and an aerosol former. The plant material may be a plant material comprising an alkaloid, more preferably a plant material comprising nicotine, and more preferably a tobacco-containing material.

The aerosol-forming substrate may comprise at least 70 percent of plant material, more preferably at least 90 percent of plant material by weight on a dry weight basis. The aerosol-forming substrate may comprise less than 95 percent of plant material by weight on a dry weight basis, such as from 90 to 95 percent of plant material by weight on a dry weight basis. The aerosol-forming substrate may comprise at least 5 percent of aerosol former, more preferably at least 10 percent of aerosol former by weight on a dry weight basis. The aerosol-forming substrate may comprise less than 30 percent of aerosol former by weight on a dry weight basis, such as from 5 to 30 percent of aerosol former by weight on a dry weight basis.

In some particularly preferred embodiments, the aerosol-forming substrate comprises plant material and an aerosol former, wherein the substrate has an aerosol former content of between 5% and 30% by weight on a dry weight basis. The plant material is preferably a plant material comprising an alkaloid, more preferably a plant material comprising nicotine, and more preferably a tobacco-containing material. Alkaloids are a class of naturally occurring nitrogen-containing organic compounds. Alkaloids are found mostly in plants, but are also found in bacteria, fungi and animals. Examples of alkaloids include, but are not limited to, caffeine, nicotine, theobromine, atropine and tubocurarine. A preferred alkaloid is nicotine, which may be found in tobacco.

The aerosol-forming substrate may comprise nicotine. The aerosol-forming substrate may comprise tobacco, for example may comprise a tobacco-containing material containing volatile tobacco flavour compounds, which are released from the aerosol-forming substrate upon heating. In preferred embodiments the aerosol-forming substrate may comprise homogenised tobacco material, for example cast leaf tobacco. The aerosol-forming substrate may comprise both solid and liquid components. The aerosol-forming substrate may comprise a tobacco-containing material containing volatile tobacco flavour compounds, which are released from the substrate upon heating. The aerosol-forming substrate may comprise a non-tobacco material. The aerosol-forming substrate may further comprise an aerosol former. Examples of suitable aerosol formers are glycerine and propylene glycol.

In some preferred embodiments, the aerosol-forming substrate may comprise a textured sheet of homogenised tobacco material with an aerosol former content of between 5% and 30% by weight on a dry weight basis. Use of a textured sheet of homogenised tobacco material may advantageously facilitate gathering of the sheet of homogenised tobacco material to form the aerosol-forming substrate.

As used herein, the term ‘aerosol former’ is used to describe any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The band of material may be suitable for forming a rod of fibrous filtration material. The band of material may be a band of fibrous tow, such as a band of fibrous cellulose acetate tow.

The band of material may be suitable for forming an aerosol-cooling element of an aerosol-generating article. The band of material may be a sheet of material selected from the group consisting of metallic foil, polymeric material, and substantially non-porous paper or cardboard. In some embodiments, the band of material may be a sheet of material selected from the group consisting of polyethylene (PE), polypropylene (PP), polyvinylchloride (PVC), polyethylene terephthalate (PET), polylactic acid (PLA), cellulose acetate (CA), and aluminium foil.

As used herein, the term ‘crimped sheet’ denotes a sheet having a plurality of substantially parallel ridges or corrugations. Preferably, when a rod formed from a crimped sheet has been assembled, the substantially parallel ridges or corrugations extend along or parallel to the longitudinal axis of the rod. This advantageously facilitates gathering of the crimped sheet to form the rod.

As used herein, the term “flavourant” is used to denote one or more organoleptic compounds or a composition comprising one or more organoleptic compounds that are applied to a substrate or article, at least in part in order to alter the taste or aroma characteristics of the substrate or article during consumption thereof. A “liquid flavourant composition” is a flavourant composition that is in a liquid form, or that can be rendered into liquid form by dissolution, suspension, or similar processes, under conditions typically encountered during storage of the flavourant composition or of the article to which the flavourant composition is to be applied.

As used herein, the term “susceptor” refers to an element comprising a material that is capable of converting electromagnetic energy into heat. When a susceptor is located in a varying magnetic field, the susceptor is heated. Heating of the susceptor may be the result of at least one of hysteresis losses and eddy currents induced in the susceptor, depending on the electrical and magnetic properties of the susceptor material.

As used herein, the terms “upstream” and “downstream” are used to describe the relative positions of components, or portions of components, of the apparatus in relation to the direction in which a band of material or component passes through the apparatus along its given path.

Below, there is provided a non-exhaustive list of non-limiting examples. Any one or more of the features of these examples may be combined with any one or more features of another example, embodiment, or aspect described herein.
EX1. An apparatus for manufacturing a component of an aerosol-generating article, the apparatus comprising: a conveyor for conveying a band of material through the apparatus along a first path; and a device disposed along the first path, the device comprising: one or more nozzles configured to apply additive to the band of material, when the band of material passes the device; and a device body comprising a contact surface for contacting the conveyed band of material as the band of material passes the device, and wherein the contact surface has a convex profile as viewed in the direction of the first path at the device.
EX2. A device according to EX1, wherein each of the one or more nozzles has an outlet defined by the contact surface.
EX3. A device according to EX1 or EX2, wherein the one or more nozzles are provided within the device body.
EX4. A device according to any of EX1 to EX3, wherein the one or more nozzles are a plurality of nozzles having outlets distributed along the convex profile of the contact surface.
EX5. A device according to any of EX1 to EX4, wherein the device body is in the form of an at least partial disc having a rim, and wherein the convex profile is defined by the rim of the at least partial disc.
EX6. A device according to any of EX1 to EX4, wherein the device body comprises a central element and a plurality of spaced apart walls radially extending outwardly from the central element and following one another in a circumferential direction around the central element, and wherein the contact surface comprises an end surface of each of the plurality of spaced apart walls.
EX7. A device according to any of EX1 to EX6, wherein the device body has one or both of: a hole extending through the device body from a first end of the device body to a second end of the device body; and a recessed portion in the device body.
EX8. A device according to any of EX1 to EX6, further comprising an additive inlet in fluid communication with the one or more nozzles.
EX9. A device according to EX8, further comprising an additive conduit within the device body for transferring additive from the additive inlet to the one or more nozzles.
EX10. A device according to EX9, further comprising an additive chamber within the device body for transferring additive from the additive conduit to the one or more nozzles.
EX11. A device according to any of EX1 to EX10, wherein the one or more nozzles are configured to apply additive to the conveyed band of material as the conveyed band passes the contact surface.
EX12. A device according to any of EX1 to EX11, wherein the one or more nozzles are integrally formed with the device body.
EX13. A device according to any of EX1 to EX11, wherein the one or more nozzles are attached to an external portion of the device body.
EX14. A device according to any of EX1 to EX13, wherein the contact surface also has a convex profile as viewed in a direction perpendicular the first axis of the body of the device.
EX15. A device according to any of EX1 to EX14, wherein the device body comprises a first part configured to be held in a fixed position in the apparatus, and a second part configured to be attachable to and removable from the first part.
EX16. A device according to EX15, wherein the second part of the device body comprises one or both of: the contact surface; and the one or more nozzles.
EX17. A device according to any of EX1 to EX16, wherein the device further comprises a heater configured to heat one or more portions of the device.
EX18. An apparatus according to any of EX1 to EX17, further comprising a funnel positioned downstream of the device, and optionally wherein the funnel has a first open end configured to receive the band of material and a second open end providing an exit point for the band of material, the first open end being positioned downstream of the device.
EX19. An apparatus according to any of EX1 to EX18, wherein the entrance of the funnel faces the device.
EX20. An apparatus according to EX18 or EX19, wherein the device is positioned within about 1 metre of the funnel.
EX21. An apparatus according to any of EX1 to EX20, further comprising a crimping device positioned upstream of the device, the crimping device being configured to crimp the band of material.
EX22. An apparatus according to EX21, wherein the crimping device is configured to crimp the band of material so that the ridges and grooves created on the crimped band of material running in a direction parallel to its direction of conveyance.
EX23. An apparatus according to any of EX1 to EX22, further comprising a pump for pumping additive to the one or more nozzles of the device.
EX24. An apparatus according to EX23, wherein the pump is separate from the device.
EX25. An apparatus according to any of EX1 to EX24 wherein the conveyor for conveyor the band of material through the apparatus along the first path is a first conveyor.
EX26. An apparatus according to EX25, wherein the first conveyor comprises one or both of: one or more rollers; and one or more conveyor belts.
EX27. An apparatus according to any of EX1 to EX26, further comprising a second conveyor for conveying a band of susceptor material through the apparatus.
EX28. An apparatus according to EX27, wherein the second conveyor is configured to convey the band of susceptor material through a hole extending through the device body.
EX29. An apparatus according to any of EX1 to EX28, wherein the device for applying additive to the conveyed band of material is a first device, and wherein the apparatus further comprises a second device for applying additive to the conveyed band of material.
EX30. An apparatus according to EX29, wherein the second device is positioned upstream of the first device.
EX31. An apparatus according to EX29 or EX30, wherein the first device is configured to apply a first additive to the conveyed band of material, and the second device is configured to apply a second additive to the conveyed band of material, and wherein the first additive is different from the second additive.
EX32. An apparatus according to any of EX29 to EX31, wherein the first device is configured to apply additive to a first portion of the conveyed band of material and wherein the second device is configured to apply additive to a second portion of the conveyed band of material, and wherein the first portion is different from the second portion.
EX33. A method of applying additive to a conveyed band of material in an apparatus for manufacturing a component of an aerosol-generating article, the method comprising: providing a device comprising one or more nozzles for applying additive to a band of material; conveying the band of material through the apparatus and past the device, such that the band of material comes into contact with a convex contact surface of the device; and transferring additive from the one or more nozzles of the device to the band of material as the band of material is conveyed past the device.
EX34. A method according to EX33, wherein the method further comprises the steps of: providing a funnel having a first open end configured to receive the band of material and a second open end providing an exit point for the band of material, the first open end being positioned downstream of the device; and conveying the band of material with transferred additive through the first open end of the funnel and out of the second open end of the funnel.
EX35. A device for applying additive to a conveyed band of material in an apparatus for manufacturing a component of an aerosol-generating article, the device comprising: a device body having a first axis extending therethrough between: a first side of the device body configured to face in a downstream direction of the conveyed band of material; and an opposed second side of the device body configured to face in an upstream direction of the conveyed band of material; a contact surface for contacting the conveyed band of material as the band of material passes the device, the contact surface residing between the first side of the device body and the second side of the device body; and one or more nozzles for applying additive to the conveyed band of material as the conveyed band passes the contact surface, wherein the contact surface has a convex profile as viewed along the first axis of the body of the device.

It will be understood that features described in relation to one example or embodiment may also be applicable to other examples and embodiments. For example, it will be understood that features which have been described so far in relation to one or more of the apparatus, the use of the apparatus and components of the apparatus configured to perform specific functions, also equates to disclosure of methods of operating the apparatus. For example, disclosure of a crimping device configured to crimp the band of material also equates to disclosure of a method step of crimping the band of material with the crimping device.

The invention will now be further described, by way of example only, with reference to the accompanying drawings in which:

FIG. 1 shows a perspective view of a device for use in an apparatus in accordance with a first embodiment of the invention;

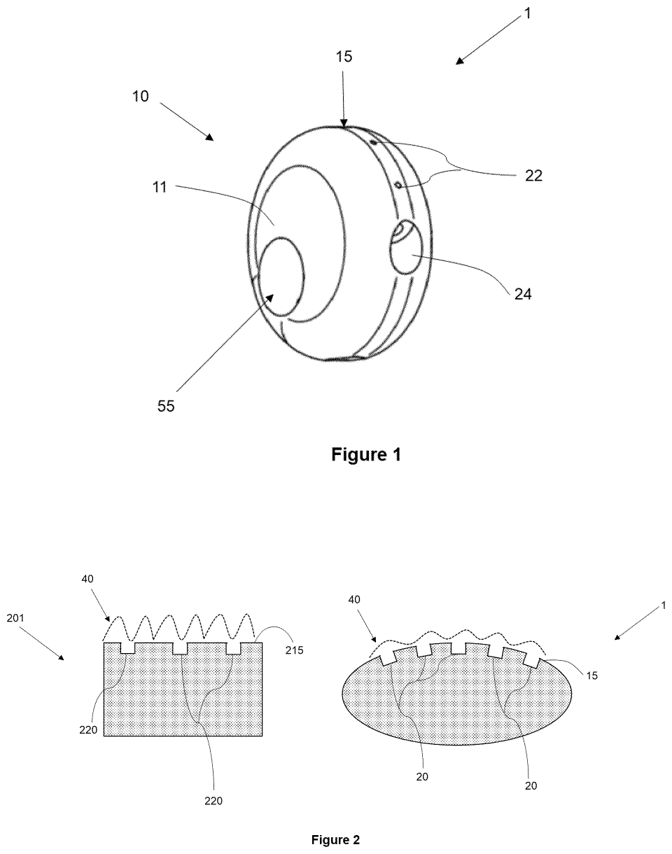

FIG. 2 shows a schematic comparative illustration of the device of FIG. 1 and a device not in accordance with the invention;

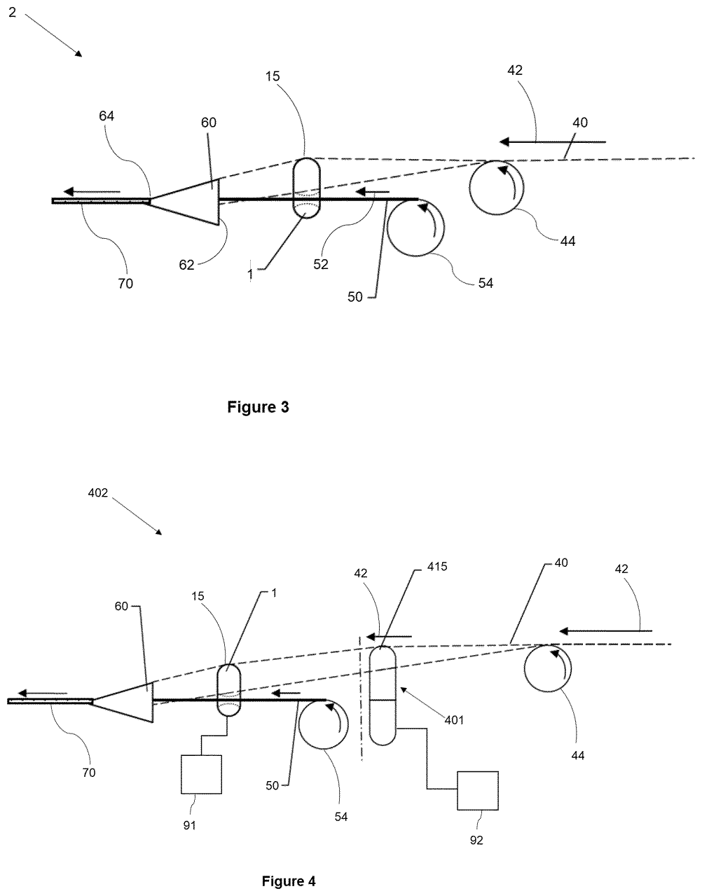

FIG. 3 shows a schematic side view of an apparatus in accordance in accordance with a first embodiment of the invention;

FIG. 4 shows a schematic side view of an apparatus in accordance in accordance with a second embodiment of the invention;

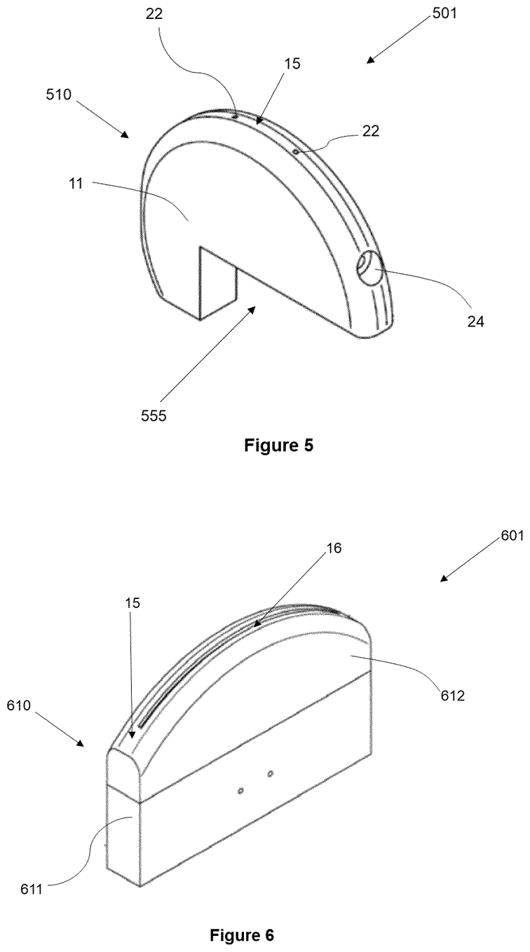

FIG. 5 shows a perspective view of a device for use in an apparatus in accordance with a third embodiment of the invention;

FIG. 6 shows a perspective view of a device for use in an apparatus in accordance with a fourth embodiment of the invention;

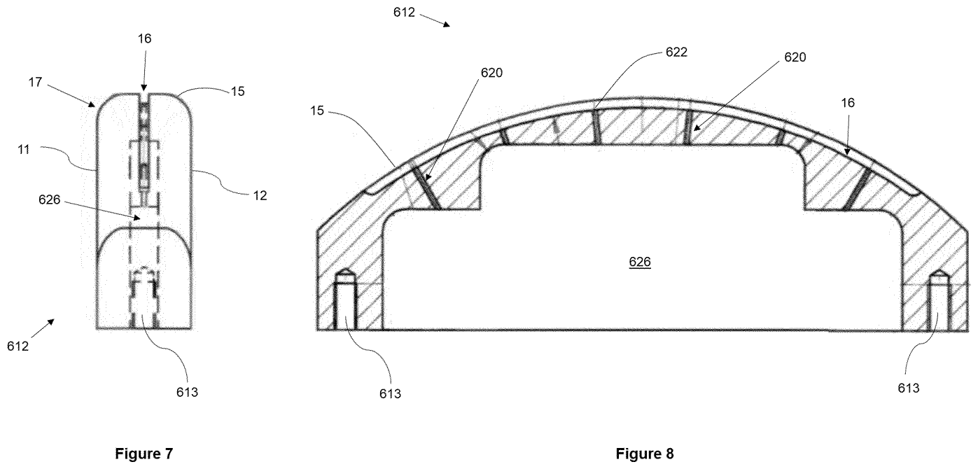

FIG. 7 shows a side view of a second part of the device of FIG. 6;

FIG. 8 shows a cross-sectional view of the second part of the device of FIG. 6;

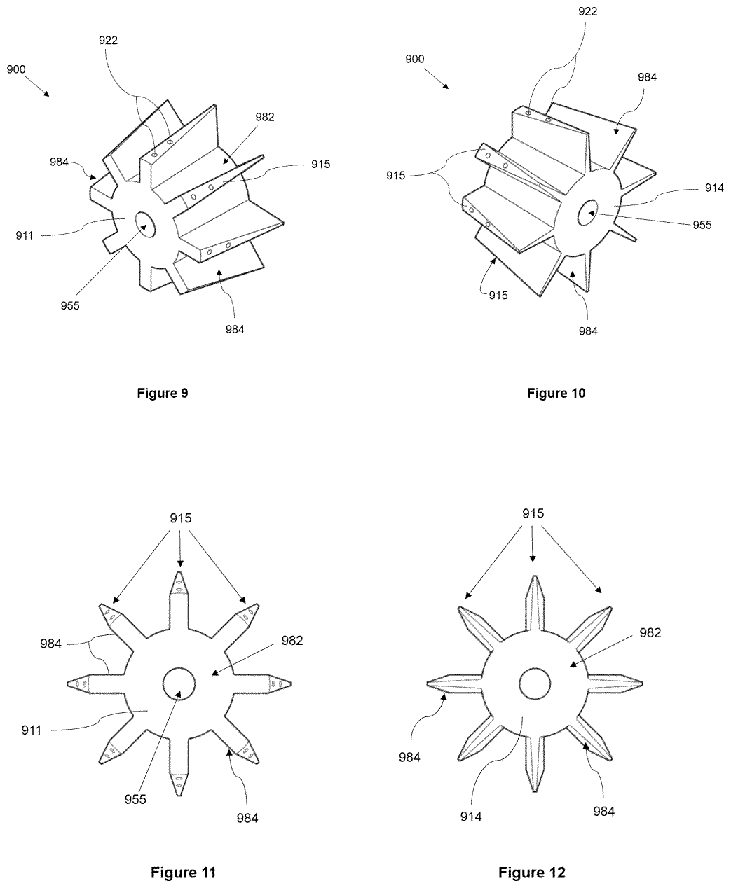

FIG. 9 shows a front perspective view of a device for use in an apparatus in accordance with a second embodiment of the invention;

FIG. 10 shows a rear perspective view of the device of FIG. 9;

FIG. 11 shows a front view of the device of FIG. 9; and

FIG. 12 shows a rear view of the device of FIG. 9.

FIG. 1 shows device 1 for use in an apparatus for manufacturing a component of an aerosol-generating article. In particular, as discussed in more detail below, the device is configured to contact a conveyed band of material in the apparatus and apply an additive to the conveyed band of material.

The device 1 comprises a device body 10, which is substantially disc shaped. The device body has a first side 11 configured to face in a downstream direction of the conveyed band of material in the apparatus. The device also has an opposed second side (not shown) configured to face in an upstream direction of the conveyed band of material in the apparatus. The device body 10 also comprises a contact surface 15 positioned between the first side 11 of the device body 10 and the second side of the device body 10. The contact surface extends around at least part of the rim of the disc shaped body 10. The contact surface 15 is configured to contact the conveyed band of material as the conveyed band of material passes the device 1 in the apparatus. Because the contact surface 15 is a rim of a substantially disc shaped body 10, the contact surface 15 forms a convex profile as viewed in the direction of conveyance of the band of material at the device, when the device is provided in the apparatus.

The contact surface 15 contains a plurality of holes, which form outlets 22 for a plurality of nozzles of the device 1. The plurality of nozzles are disposed within the device body 10 and not visible in FIG. 1. The nozzles are configured to eject an additive from the device body 10 through the outlets 22, so that the additive can be applied to the conveyed band of material when the band of material passes and comes into contact with the contact surface 15 of the device 1.

The device of FIG. 1 also has an additive inlet 24 for enabling additive to be pumped into the device body 10. Although not visible in FIG. 1, the additive may pass from the additive inlet 24 to the nozzles and then out of the outlets 22.

The device of FIG. 1 also has a hole 55 in the device body 10. The hole 55 extends through the device body 10 from the first side 11 of the device body 10 to the second side of the device body 10. As will be described in more detail below with reference to FIG. 3, the hole is included so that a band of susceptor material may pass through the device body 10 without interacting with the contact surface 15 or one or more nozzles of the device 1.

FIG. 2 shows a schematic comparative illustration of the device 1 of FIG. 1 and a device 200 not in accordance with the invention. The device 200 not in accordance with the invention is cube shaped and provides a flat contact surface 215 for engaging with the conveyed band of material. As illustrated in FIG. 2, the conveyed band of material is a crimped sheet of material 40. The crimped sheet has a plurality of substantially parallel ridges or corrugations, which extend in the direction of conveyance of the crimped sheet 40.

In the device 200 not in accordance with the invention, the crimped sheet 40 is unaffected by the flat contact surface 215 of the device. Consequently the ridges or corrugations of the crimped sheet 40 are reasonably pronounced. This results in portions of the crimped sheet being not readily available for receipt of additive from the nozzles 220 of the device 200.

In contrast, the convex contact surface 15 of device 1 in FIG. 2 imposes a reaction force on the crimped sheet 40 as the crimped sheet 40 comes into contact with the convex contact surface 15. This force acts to spread the crimped sheet 40 in a transverse direction around the device 1 as the crimped sheet 40 passes the device 1. This has the effect of reducing the severity of the crimping or corrugation in the crimped sheet 40 and thus helps to increase the surface area of the crimped sheet 40 which is readily available for additive application.

FIG. 3 shows a schematic side view of an apparatus 2 in accordance in accordance with a first embodiment of the invention. Arrows are used in FIG. 3 to indicate movement of components of the apparatus. The apparatus comprises the device 1 of FIG. 1. The apparatus 2 also comprises a sheet of crimped aerosol-forming substrate 40, which is conveyed through the apparatus 2 along a first path 42 by a first conveyor comprising a first rotating roller 54. The apparatus 2 also comprises a band of susceptor material 50, which is conveyed through the apparatus 2 along a second path 52 by a second conveyor comprising a second rotating roller 54. The apparatus also comprises a funnel 60 disposed downstream of the first device 1. The funnel 60 comprises an open upstream end 62 and an open downstream end 64, through which the sheet of crimped aerosol-forming substrate 40 and band of susceptor material 50 are fed. The open upstream end 62 is the larger end of the funnel 60, so that as the sheet of crimped aerosol-forming substrate 40 and band of susceptor material 50 are fed through the funnel 60 they are gathered into a rod 70, which is conveyed out of the funnel 60 and conveyed for downstream in the apparatus 2. The open upstream end 62 of the funnel 1 is positioned downstream of the first device 1, such that the entirety of the funnel 60 resides downstream of the device 1.

As shown in FIG. 3, when the sheet of crimped aerosol-forming substrate 40 passes the device 1 along the first path 42, the sheet of crimped aerosol-forming substrate 40 comes into contact with the contact surface 15 of the first device 1. Due to the shape and position of the first device 1 and its convex contact surface 15, the sheet of crimped aerosol-forming substrate 40 is pulled and spread over the convex contact surface 15 during such conveyance. This is indicated by the two dotted lines in FIG. 3 at the first device 1. Furthermore, when the sheet 40 is passing over and in contact with the contact surface 15, nozzles in the body of the device 1 apply additive to the surface of the sheet 40. Shortly thereafter, the shaped and additive containing crimped sheet of aerosol-forming substrate 40 is fed into the funnel 60 where it is gathered into a rod 70 in combination with the band of susceptor material 50.

Providing the device 1 having such a shape, position and orientation in the apparatus 2 has at least two notable effects on the function of the apparatus 2. Firstly, the device 1 shapes the sheet of crimped aerosol-forming substrate 40 into a form more suitable for receiving additive, by reducing the severity of the crimping of the sheet 40 when at the device 1. Secondly, the device 1 shapes the sheet of crimped aerosol-forming substrate 40 into a form more suitable for being received by the downstream funnel 60, by pre-shaping the sheet 40 into a convex curved profile. In doing so, the sheet 40 may be more suitable for being received into the funnel 60. This can reduce the likelihood of jamming occurring when the sheet 40 is fed into the funnel 60. Furthermore, by applying additive to the underside of the sheet 40 in the manner shown in FIG. 3, the additive is not on a surface of the sheet 40 which would come into direct contact with the inner surface of the funnel 60. This can reduce the likelihood of the funnel 60 impacting one or both of the amount or the location of the additive carried by the sheet 40. This can also reduce the likelihood of the additive impacting the performance of the funnel 60.

FIG. 4 shows a schematic side view of an apparatus 402 in accordance in accordance with a second embodiment of the invention. The apparatus 402 of FIG. 4 is similar to the apparatus 2 of FIG. 3 in that it also comprises the crimped sheet of aerosol-forming substrate band of susceptor material 50, gathered rod 70, funnel 60, device 1, first roller 44 and second roller 54. However, in the apparatus 402 of FIG. 4 the device 1 is a first device 1, and the apparatus 402 further includes a second device 401. The apparatus 402 of FIG. 4 also further comprises a first pump 91 for supplying additive to the first device 1, and a second pump 92 for supplying additive to the second device 401.

The second device 401 is positioned upstream of the first device 1. The second device 401 comprises a contact surface 415, which contacts the crimped sheet 40 as the crimped sheet passes the second device 415. The contact surface 415 of the second device 401 has a convex profile as viewed in the direction of the first path 42 at the second device 415. Consequently, when the crimped sheet 40 is conveyed past the second device 401, the crimped sheet 40 is spread in a curved shape around the second device 401. Although not shown in the schematic illustration of FIG. 4, the second device 401 also comprises a plurality of nozzles, which apply additive to the crimped sheet 40 as the crimped sheet 40 passes the second device 401. The additive applied by the second device 401 may be a different type of additive to that which is applied by the first device 1. Alternatively or additionally, the additive applied by the second device 401 may be applied to a different portion or portions of the crimped sheet 40 to the portion or portions on which additive from the first device 1 is applied.

FIG. 5 shows a perspective view of a device 501 for use in an apparatus in accordance with a third embodiment of the invention. The device 501 is similar to the device 1 of FIG. 1 in that it has a device body 510 which is generally disc shaped. However, in FIG. 5, the device body 510 only forms the shape of a partial disc. That is, the curved rim of the device body 510 does not extend around the entire periphery of the disc. Furthermore, the device body 510 does not comprise a hole 55 extending therethrough for the passage of a band of susceptor material. Instead, the device body comprises a recessed portion 555, which is spaced away from the contact surface 15 and nozzle outlets 22 of the device body 510. When the device 501 is placed in an apparatus, such as the apparatus of FIG. 3 or 4, the recessed portion 555 may enable a band of susceptor material to pass the device 501 without interacting with the contact surface 15 or one or more nozzles of the device 501.

FIG. 6 shows a perspective view of a device 601 for use in an apparatus in accordance with a fourth embodiment of the invention. The device 601 of FIG. 6 is similar to the device 501 of FIG. 5 in that it has a device body 610 which is partially disc shaped. However, in FIG. 6, the device body 610 is formed of two parts. In particular, the device body 610 comprises a first part 611 configured to be held in a fixed position in the apparatus, and a second part 612 configured to be removable from and attachable to the first part 611. The second part 612 may be interchange with other second parts. This may allow for simple modification of one or more properties of the device 601. The second part 612 comprises the contact surface 15 of the device 601 and a groove 16 extending along the curvature of the rim 17 of the device body 610. Disposed within the groove 16 are the outlets of the plurality of nozzles of the device (not visible in FIG. 6). The groove 16 is delimited by the contact surface 15.

FIG. 7 shows a side view of the second part 612 of the device of FIG. 6 in partial cross-section. FIG. 8 shows a cross-sectional view of the second part 612 of the device of FIG. 6. As can be seen from FIGS. 7 and 8, the second part 612 of the device body 610 comprises a plurality of recesses 613 for receiving complementary attachment pins from the first part 611 of the device body 610. These provide an attachment mechanism for allowing the second part 612 to be attachable to and removable from the first part 611. The second part 612 also comprises an internal additive chamber 626 for housing the additive with the plurality of nozzles 620 being in fluid communication with the additive chamber 626. The plurality of nozzles 620 are evenly spaced along the rim 17 of the second part 612, with the outlet 622 of each nozzle being disposed in the base of a groove 16, which also extends along the rim 17 of the second part 612.

As best seen from FIG. 7, the rim 17 of the second part 612 of the device body is rounded. In particular, the rim curves when moving in a direction from the first side 11 of the device body 610 to the second side 612 of the device body 610. This results in the contact surface also having a convex profile as viewed in a direction perpendicular the direction of direction of the first path at the device, namely the view shown in FIG. 7.

FIG. 9 shows a front perspective view of a device 900 for use in an apparatus in accordance with a second embodiment of the invention. The device 900 of FIG. 9 may be used in one or both of the apparatus of FIG. 3 and the apparatus of FIG. 4 instead of or in addition to devices 1 and 401.

As shown in FIG. 9, the device 900 comprises a device body comprising central element 982 and a plurality of spaced apart walls 984 radially extending outwardly from the central element 982 and following one another in a circumferential direction around the central element 982. In this embodiment, the contact surface 915 comprises an end surface of each of the plurality of spaced apart walls 984, with the outlets 922 being disposed on the end surfaces of each wall 984. The convex profile of the contact surface 915 is therefore defined by the manner in which the end surfaces of the plurality of spaced apart walls 984 are distributed around the central element 982 of the device body. Consequently, in the embodiment of FIG. 9, the contact surface 915 is formed by a plurality of surfaces rather than a single surface. In such an embodiment, as the band of material reaches the device, the band of material passes into contact with the end surface of at least some of the spaced apart walls. Since these end surfaces are distributed in a convex profile around the central element, the band of material may therefore be subjected to similar forces as would be produced if the band of material were passed over a single continuous convex surface. That is, the spaced apart walls 984, and in particular their end surfaces 915, can help to stretch or otherwise spread the band of material in a curved shaped around the device 900 as the band of material passes the device 900.

By providing a plurality of spaced apart walls 984 radially extending outwardly from the central element 982, an empty space is formed between two adjacent spaced-apart walls 984.

In FIG. 9, the central element 982 is substantially cylindrical shaped. A longitudinal axis of the central element 982 is arranged to extend in substantially the same direction as the first path of the band of material at the device 900. The longitudinal axis of the central element 982 is therefore substantially aligned with the direction of the first path of the band of material at the device 900.

FIG. 9 depicts a front perspective view of the device 900 and thus shows the front or downstream end face 911 of the device 900. FIG. 10 depicts a rear perspective view of the device 900 and thus shows the rear or upstream end face 914 of the device 900. A hole 955 is also provided in the central element 982. The hole 955 extends through the central element 982 from the downstream end face 911 of the central element 982 to the upstream end face 914 of the device body 10. These features can also be appreciated from FIGS. 11 and 12 which respectively depict a front view and a rear view of the device 900.

For ease of viewing not all of the walls in FIGS. 9 to 12 have been labelled with reference numeral 984. Similarly, not all of the end surfaces of these walls have been labelled with reference numeral 915. It will be appreciated that the contact surface 915 may be formed by any combination of the walls 984 of the device 900, provided they form a convex profile as viewed in the direction of the first path at the device 900.

1.-14. (canceled)

15. An apparatus for manufacturing a component of an aerosol-generating article, the apparatus comprising:
a conveyor configured to convey a band of material through the apparatus along a first path; and
a device disposed along the first path, the device comprising:
one or more nozzles configured to apply additive to the band of material, when the band of material passes the device, and
a device body comprising a contact surface configured to contact the conveyed band of material as the band of material passes the device,
wherein the contact surface has a convex profile as viewed in a direction of the first path at the device; and
a funnel having a first open end configured to receive the band of material and a second open end providing an exit point for the band of material, the first open end being positioned downstream of the device.

16. The apparatus according to claim 15, wherein each of the one or more nozzles has an outlet defined by the contact surface.

17. The apparatus according to claim 15, wherein the one or more nozzles are a plurality of nozzles having outlets distributed along the convex profile of the contact surface.

18. The apparatus according to claim 15,
wherein the device body is in the form of an at least partial disc having a rim, and
wherein the convex profile is defined by the rim of the at least partial disc.

19. The apparatus according to claim 15,
wherein the device body further comprises a central element and a plurality of spaced apart walls radially extending outwardly from the central element and following one another in a circumferential direction around the central element, and
wherein the contact surface comprises an end surface of each of the plurality of spaced apart walls.

20. The apparatus according to claim 15, wherein the device body has one or both of:
a hole extending through the device body from a first end of the device body to a second end of the device body, and
a recessed portion in the device body.

21. The apparatus according to claim 15, wherein the one or more nozzles are attached to an external portion of the device body.

22. The apparatus according to claim 15, wherein the contact surface also has a convex profile as viewed in a direction perpendicular a first axis of the body of the device.

23. The apparatus according to claim 15, wherein the device body further comprises a first part configured to be held in a fixed position in the apparatus, and a second part configured to be attachable to and removable from the first part.

24. The apparatus according to claim 15, further comprising a crimping device positioned upstream of the device, the crimping device being configured to crimp the band of material.

25. The apparatus according to claim 15, further comprising a second conveyor configured to convey a band of susceptor material through the apparatus.

26. The apparatus according to claim 15,
wherein the device is a first device, and
wherein the apparatus further comprises a second device configured to apply additive to the conveyed band of material.

27. The apparatus according to claim 26,
wherein the first device is configured to apply additive to a first portion of the conveyed band of material,
wherein the second device is further configured to apply additive to a second portion of the conveyed band of material, and
wherein the first portion is different from the second portion.

28. A method of applying additive to a conveyed band of material in an apparatus for manufacturing a component of an aerosol-generating article, the method comprising:
providing a device comprising one or more nozzles for applying additive to a band of material;
providing a funnel having a first open end configured to receive the band of material and a second open end providing an exit point for the band of material, the first open end being positioned downstream of the device;
conveying the band of material through the apparatus and past the device, such that the band of material comes into contact with a convex contact surface of the device;
transferring additive from the one or more nozzles of the device to the band of material as the band of material is conveyed past the device; and
conveying the band of material with the transferred additive through the first open end of the funnel and out of the second open end of the funnel.
